(19) United States
(12) Patent Application Publication
(10) Pub. No.: US 2026/0365818 A1
(43) Pub. Date: Nov. 19, 2026

(54) A PROCESS FOR OBTAINING A RECYCLED POLYOL AND A POLYOL OBTAINED HEREBY

(71) Applicant: Polytech A/S, Bramming (DK)

(72) Inventor: Hülya UCAR, Vejen (DK)

(73) Assignee: Polytech A/S, Bramming (DK)

(21) Appl. No.: 19/148,120

(22) PCT Filed: Feb. 7, 2024
(86) PCT No.: PCT/EP2024/053086

§ 371 Date: Jul. 15, 2025

(30) Foreign Application Priority Data
Feb. 10, 2023 (EP) 23156095.4

(51) Int. Cl. C08J 11/26; C08J 11/24

(52) U.S. Cl. CPC C08J 11/26; C08J 11/24; C08J 2375/08; C08J 2471/02

(57) ABSTRACT

Recovery of high-quality polyols from polyurethane wastes using a three-phase glycolysis process by bringing the polyurethane in contact with a catalyst and a glycolyzing compound to obtain a reaction mixture; reacting the reaction mixture for a predefined reaction time to create a recycled mixture; separating the recycled mixture into three immiscible phases to obtain the high-quality polyols in a polyol phase; and using the recovered polyol phase as a polyol component in a process for making another polyurethane product.

### TECHNICAL FIELD

The invention relates to a method of recovering/recycling a polyol compound from a polyurethane product, where the recycled polyol is useful as a starting material for making a new polyurethane product.

### BACKGROUND ART

Polyurethane polymers are generally produced by the reaction of a poly-isocyanate, particularly diisocyanates, with hydroxyl-rich compounds such as glycols and polyester and polyether polyols. The chemical nature as well as the functionality of the reagents are selected based on the final desired chemical and physical properties of the polyurethane product. Consequently, the polyurethane products are widely used in a large amount not only as flexible, semirigid, rigid, and reinforced rigid cellular polyurethanes in furniture and bedding, cushioning materials in the automotive industry, and due to the good heat isolation capacity of rigid foams frequently for thermal isolation, for example in the construction industry or in the refrigeration industry, but also as applications within the field as an in shoe soles, as coatings, adhesives or sealants, and as components within the wind turbine field such as transport equipment and solutions, leading edge protection and elements of a lightning protections system.

Due to the variety of applications and extensive industrial use of polyurethane polymers, the production of polyurethane polymers has increased in the past decades, leading to an increase and accumulation of waste, as well as an increase of the concern about the disposal of the accumulated waste and/or scrap polyurethane polymer. Today, the majority of polyurethane waste is disposed of by landfill and incineration. However, such disposal routes, besides representing an environmental pollution problem, have an economic loss associated with both the land required for landfill and the costly materials used in the preparation of the foam disposed in these operations.

It is therefore of interest to consider the recovery and eventual reuse of such materials. The reuse of plastics and polyurethane foams in particular has been described and consists mainly of energy recovery, mechanical recycling and chemical depolymerisation. The energy recovery is not exactly a recycling process, but it is a process wherein the polyurethane is used as a fuel to recover heat and vapor thereof. It is well known that the exhaust fumes produced should be strictly controlled to avoid new pollution problems. Mechanical polyurethane waste recycling processes are limited by the thermoset character of the polyurethane foams, causing problems upon the qualities of the products. e.g. making it impossible to melt and remould polyurethane waste. Shredding and imbedding the polyurethane waste as a filler in new materials is possible, but significantly reduces the quality of the end product.

On the other hand it is highly desirable to use the polyurethane chemical components in new product manufacture. Thus, it is the general purpose of polyurethane chemical recycling to recover one or more of its constituents which has a particular commercial interest, such as the polyol, a valuable raw material which may be used to manufacture new polyurethane polymer products, if the desired purity can be obtained.

Examples of chemical depolymerisation of polyurethanes are hydrolysis, hydroglycolysis, aminolysis, and glycolysis.

Hydrolysis and hydroglycolysis of polyurethane and polyurea-polyurethanes is a decomposition of polyurethane by treating the polyurethane materials with superheated steam or hot water and basic compounds such as ammonia or ammoniun hydroxide. If it is the hydroglycolysis that is carried out, it involves the presence of a suitable organic solvent such as polyol or glycol.

Aminolysis processes involves treating the polyurethane at high temperature with a liquid mixture, consisting of an alkanolamine and a catalyst, such as a metal hydroxide, to obtain both the polyol and the amine.

Glycolysis (or alcoholysis), involves mixing polyurethanes and/or polyurea-polyurethane products with compounds containing at least two reactive hydroxyl groups. The mixture is reacted to produce a liquid product comprising a mixture of compounds containing hydroxyl end groups, i.e., a recycled polyol. The recycled polyol can be employed alone or in combination with virgin polyols to prepare polyurethane compounds but may also be used in various polyurethane, polyurea-polyurethane and polyisocyanurate applications.

However, the recycled polyol phase often contains contaminations, which entails a need for further purification, after the glycolyzing compound has reacted with the polyurethane product. Thus, there is still a need within the field to provide a process in which a less contaminated recycled polyol phase is obtained, without the need for further purification, after the glycolyzing compound has reacted with the polyurethane product.

There is further a need for obtaining a cleaner/less contaminated middle phase.

### SUMMARY

The present invention solves this problem by providing a high-quality recovered polyol from a polyurethane product using a three-phase process wherein the polyurethane product is glycolyzed by using a catalyst and a glycolyzing compound comprising at least two hydroxyl groups and is selected from one or more long chain glycols having a specifically selected molecular weight, where the reaction mixture afterwards will split into an upper phase, a middle phase, and a bottom phase, wherein the upper phase is mainly formed by the recovered polyol (and may contain small amounts of unreacted glycolyzing compound). The middle phase normally comprises the solvent (i.e., the glycolyzing compound). The middle phase may further be used in another run of the process, i.e. in another batch.

By using the given glycolyzing compound, the present invention obtains three phases, where the difference between the recycled polyols from the polyurethane product and the glycolyzing compound used, provides a good phase separation between these two phases, such that the polyol phase is less contaminated with glycolyzing compound compared to a process where a glycolyzing compound outside the molecular weight is used. Such a phase separation is further optimized by utilizing a glycolyzing compound that has a density and/or molecular weight different than the polyol that is to be obtained by the recycling. In this way, a sharper and better phase separation between the two phases is obtained, as the denser, preferably the glycolyzing compound will make a layer below the less dense recycled polyol. It is therefore disclosed herein that the polyol to be recycled need to not completely resemble the glycolyzing compound used, and vice versa.

A typical polyol being recycled in the herein disclosed process may have a density of about 0.98 to about 1.05 g/cm³. However, it is a higher functional polyether polyol based on sucrose is can have a density of 1.11 g/cm³. A PEG400, which is one of the glycolyzing compounds used herein has a density of about 1.13 g/cm³. Glycerol has a density of 1.25 g/cm³.

Further, by this combination of polyurethane and glycolyzing compound the middle phase obtains a better separation between the upper and bottom phase, such that the remaining unreacted glycolyzing compound can be reused in another process for recycling a polyol without the need for further purification.

Thus, the process for preparing the recycled polyol comprises bringing a polyurethane product into contact with a glycolyzing compound containing at least two hydroxyl groups, and letting the polyurethane and the glycolyzing compound react at an elevated or high temperature in the presence of a catalyst. By means of the use of an excess of a glycolyzing compound and a suitable glycolyzing compound, the reaction product will be split into three phases, where the upper layer is mainly formed by the recovered polyol from the polyurethane, the middle layer is formed by the excess of the glycolyzing compound, and the bottom layer is formed by the isocyanate-derivative and aromatic dicarbamate obtained when hydrolysing the polyurethane. The upper layer/phase can be further purified if needed by e.g. a liquid-liquid extraction using an aqueous phase and the excess of glycolyzing compound in the middle phase can be recycled to and reused in the process by vacuum distillation, if higher purity is needed.

The middle layer formed by the excess of the glycolyzing compound may also be disclosed herein as a middle layer/phase formed by the solvent, as the process preferably uses the glycolyzing compound in molar excess as the solvent for the process.

Hence, disclosed herein in a first aspect is a process for obtaining a recycled polyol from a first polyurethane and use of said polyol as a component in a second polyurethane, wherein the process comprises the steps of:
a. bringing the first polyurethane in contact with a catalyst and a molar excess of a glycolyzing compound to obtain a reaction mixture, wherein the glycolyzing compound comprises at least two hydroxyl groups and is selected from one or more long chain glycols having a molecular weight between 180 and 1100 g/mol;
b. reacting the reaction mixture of step a) at a reaction temperature between 170 degrees C and 220 degrees C for a predefined reaction time between 30 minutes and 240 minutes to create a recycled mixture;
c. separating the recycled mixture of step b) into at least three immiscible phases to obtain at least a recovered polyol phase, a glycolyzing compound phase, and a waste phase; and
d. using the recovered polyol phase as a polyol component in a process for making the second polyurethane;
   wherein the glycolyzing compound and the first polyurethane are selected such that the glycolyzing compound has a density higher than the recycled polyol.

The present invention hereby provides a process in which the specific combination of polyurethane and glycolyzing compound provides a split-phase reaction in which the reaction mixture will separate into three phases after end reaction. In this way, the present invention solves the problem by providing a high-quality recovered polyol from a polyurethane product in one phase and the remaining glycolyzing compound in another phase. The polyol phase will hereby be less contaminated as a better phase separation is obtained. Further, by having a third phase comprising the isocyanate-derivative and aromatic dicarbamate residues, the remaining glycolyzing compounds can be used directly in another process cycle for recycling polyol without the need for further purification. Thus, in one or more embodiments, the glycolyzing compound phase is reused as the glycolyzing compound in another process for obtaining recycled polyol.

As the recycled polyol obtained from the process is less contaminated, and as the recycled polyol is used in the process as a polyol component in a process for making another polyurethane product, the hereby obtained polyurethane product will be of a better quality, compared to the use of a recycled polyol being more contaminated with glycolyzing compound, or other derivatives, after end reaction. Preferably, the recycled polyol is used without further purification in a process for making another polyurethane product. Hence, in one or more embodiments, the recovered polyol phase is used directly as a polyol component in a process for making a new polyurethane.

The waste phase as disclosed herein may also be termed the isocyanate-derivative and aromatic dicarbamate phase, as it is most likely that some of said compounds could be found in this phase. However, depending on the isocyanate-derivative and aromatic dicarbamate created, these may also be found in the other phases, but will have no impact on the reuse of the polyol. Other component will also be found in the waste phase.

Disclosed herein in a second aspect is a polyurethane prepared from a polyol mixture and one or more isocyanates, wherein the polyol mixture comprises at least 5% by weight of a recovered polyol phase obtained from the process for obtaining a recycled polyol according to the first aspect, such as at least 10% by weight, such as at least 15% by weight, such as at least 20% by weight, such as at least 25% by weight, such as at least 30% by weight, or such as at least 35% by weight of a recovered polyol phase.

The glycolyzing compound may further be narrowed down, depending on the starting polyurethane; hence, in one or more embodiments, the glycolyzing compound is selected from one or more polyethylene glycols having a molecular weight between 380 and 420 g/mol, such as PEG 400.

The polyurethane may be an elastomeric polyurethane; hence in one or more embodiments, the first polyurethane and/or the second polyurethane is a polyurethane elastomer. By “elastomer” is meant a polymer with viscoelasticity (i.e. both viscosity and elasticity) and with weak intermolecular forces, generally low Young's modulus and high failure strain compared with other materials. Alternatively, the polyurethane may be a polyurethane foam; hence in one or more embodiments, the first polyurethane and/or the second polyurethane is a polyurethane foam.

The phase separation could preferably be sharper (i.e. less contamination between two phases) by either spinning the recycled mixture or by leaving the reaction mixture for a predefined period, preferably while the reaction mixture is at an elevated temperature. This will ensure that the vast majority of remaining unreacted glycolyzing compound is separated into the middle phase, while the obtained recycled polyol and isocyanate-derivative and aromatic dicarbamate residues are separated into the upper- and bottom layer, respectively. This will further enhance the purity of each phase, hereby further enabling the recycled polyol and/or unreacted glycolyzing compound to be reused without further purification. Therefore, in one or more embodiments, the separation step c) is by spinning the recycled mixture with at least 3000-10000 rpm for a predefined period; by maintaining or heating the recycled mixture to at least 30 degrees C, such as at least 40 degrees C, for a predefined period of at least 15 minutes; and/or by leaving the recycled mixture for a predefined period of at least 30 minutes. In one or more embodiments, the separation step c) is leaving the recycled mixture for a predefined period of at least 45 minutes, such as a predefined period of at least 1 hour, such as a predefined period of at least 6 hours, or such as a predefined period between 12 and 48 hours.

The recycled polyol obtained in the upper phase is used in step d) as a component in a process for making another polyurethane, which could have similar or different properties compared to the polyurethane product from which it is recycled. As the purity of the recycled polyol is high, the polyol may be used in a large wt. %, such as up to 60-70 wt. % depending on the physical and chemical properties needed from the polyurethane product to be produced. Hence, in one or more embodiments, the polyol phase is used in up to 60 wt. %, such as between 30 and 50 wt. %, of the total amount of reaction mixture used for making the second polyurethane. Additionally, the polyurethane product from which the polyol is to be recycled from may be the same polyurethane product as the one to be produced by the recycled polyol. Accordingly, in one or more embodiments, the first and second polyurethane are substantially the same polyurethane.

After end reaction, during step c) the process may further be cooled down, by leaving the reaction mixture at room temperature. Alternatively, the reaction may be actively cooled by cooling the recycle mixture at a predefined temperature. It is preferred that a temperature above room temperature is actively applied to the reaction mixture, such as a temperature at or above 30 degrees C. Thus, in one or more embodiments, the process further comprises cooling the recycled mixture prior to separating the recycled mixture in step c), wherein the cooling is conducted at a temperature of about 30 degrees C to about 60 degrees C, such as about 40 degrees C to about 50 degrees C. The reaction mixture may additionally be kept at the cooling temperature for a predefined period, as disclosed herein.

Further, various catalysts may be used in the disclosed process, such as potassium hydroxide or a metal acetate salt, such as zinc acetate. In one or more embodiments, the catalyst is selected from a metal acetate salt, such as zinc acetate. The catalyst may be used in various wt. % based on the weight of the polyurethane product from which the polyol is to be recycled from. Such amounts could be e.g. 2 to 4 wt. % based on 100 wt. % polyurethane. Hence, in one or more embodiments, the catalyst is in a concentration between 2 and 4 wt. % compared to 100 wt. % first polyurethane.

The ratio between the polyurethane from which the polyol is to be recycled and the glycolyzing compound may also be varied. However, a molar excess of glycolyzing compound compared to polyol compounds to be cleaved in the polyurethane product is preferred. This may be achieved by always having an equal or excess amount of glycolyzing compound to polyurethane product, if measuring by weight. Therefore, in one or more embodiments, the polyurethane and the glycolyzing compound is mixed in a ratio between 1:1 and 1:2. This ratio is a ratio between the weight of the polyurethane and the weight of the glycolyzing compound. E.g. if 10 kg polyurethane is to be treated in the process, 10 to 20 kg glycolyzing compound could be used.

Other parameters of the process may be varied, such as reaction temperature and reaction time. Therefore, in one or more embodiments, the reaction temperature is between 180 degrees C and 190 degrees C. In one or more embodiments, the reaction temperature is between 170 degrees C and 190 degrees C. In one or more embodiments, the reaction temperature is between 180 degrees C and 185 degrees C. In one or more embodiments, the reaction temperature is between 180 degrees C and 220 degrees C. In one or more embodiments, the reaction temperature is between 190 degrees C and 220 degrees C. In one or more embodiments, the reaction temperature is between 190 degrees C and 210 degrees C. In one or more embodiments, the reaction temperature is between 195 degrees C and 205 degrees C.

In one or more embodiments, the predefined reaction time is between 30 minutes and 150 minutes, such as 60 minutes and 100 minutes. In one or more embodiments, the predefined reaction time is between 60 minutes and 120 minutes, such as 60 minutes and 80 minutes. In one or more embodiments, the predefined reaction time is between 60 minutes and 240 minutes. In one or more embodiments, the predefined reaction time is between 90 minutes and 220 minutes. In one or more embodiments, the predefined reaction time is between 120 minutes and 200 minutes. In one or more embodiments, the predefined reaction time is between 150 minutes and 200 minutes. In one or more embodiments, the predefined reaction time is between 170 minutes and 190 minutes.

The reaction time and the reaction temperature are optimised to maximise the reaction between the carbamate groups in the polyurethane to be recycled and the hydroxyl groups of the glycolyzing compound, such that the original polyols used to make the polyurethane are cleaved from the carbamate group hereby releasing these polyols. The reaction time and the reaction temperature are further optimised to minimise any side-reaction taking place.

Further, step a) of the process may be split into three steps. In one or more embodiments, step a) comprises the following steps:
a1) providing the molar excess of the glycolyzing compound;
a2) adding the first polyurethane to the glycolyzing compound to obtain a pre-reaction mixture; and
a3) adding the catalyst to the pre-reaction mixture of step a2) to obtain the reaction mixture.

Further, disclosed herein in a third aspect is a process for obtaining a recycled polyol from a first polyurethane and use of said polyol as a component in a second polyurethane, wherein the process comprises the steps of:
a. bringing the first polyurethane in contact with a catalyst and a molar excess of a glycolyzing compound to obtain a reaction mixture, wherein the glycolyzing compound comprises at least two hydroxyl groups and is selected from one or more long chain glycols having a molecular weight between 180 and 1100 g/mol;
b. reacting the reaction mixture of step a) at a reaction temperature between 170 degrees C and 200 degrees C for a predefined reaction time between 30 minutes and 150 minutes to create a recycled mixture;
c. separating the recycled mixture of step b) into at least three immiscible phases to obtain at least a recovered polyol phase, a glycolyzing compound phase, and an isocyanate-derivative and aromatic dicarbamate phase; and
d. using the recovered polyol phase as a polyol component in a process for making the second polyurethane.

The present disclosure will become apparent from the detailed description given below. The detailed description and specific examples disclose preferred embodiments of the disclosure by way of illustration only. Those skilled in the art understand from guidance in the detailed description that changes and modifications may be made within the scope of the disclosure.

### DETAILED DESCRIPTION

The description herein of any aspect or embodiment of the invention using terms such as “comprising”, “having,” “including,” or “containing” with reference to an element or elements is intended to provide support for a similar aspect or embodiment of the invention that “consists of”, “consists essentially of”, or “substantially comprises” that particular element or elements, unless otherwise stated or clearly contradicted by context, e.g. a composition described herein as comprising a particular element should be understood as also describing a composition consisting of that element, unless otherwise stated or clearly contradicted by context. It will be further understood that the terms “comprises,” “comprising,” “includes” and/or “including,” when used in this specification, specify the presence of stated features, integers, steps, operations, elements, and/or components, but do not preclude the presence or addition of one or more other features, integers, steps, operations, elements, components, and/or groups thereof.

As used herein, the singular forms “a,” “an,” and “the” are intended to include the plural forms, including “at least one,” unless the content clearly indicates otherwise. “At least one” is not to be construed as limiting “a” or “an.”

Unless otherwise defined, all terms used herein (including technical and scientific terms) have the same meaning as commonly understood by those skilled in the art to which this invention pertains. It will be further understood that terms, such as those defined in commonly used dictionaries, should be interpreted as having a meaning that is consistent with their meaning in the context of the relevant art and will not be interpreted in an idealized or overly formal sense unless expressly so defined in the present specification.

Effects and features of the second aspect is to a large extent analogous to those described above and below in connection with the first aspect. Embodiments mentioned in relation to the first aspect are largely compatible with the second aspect.

The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

As discussed above, the present invention relates to solving the problem of providing a process in which a less contaminated recycled polyol phase is obtained, without the need for further purification, after the glycolyzing compound has reacted with the polyurethane product. The present invention solves this problem by providing a high-quality recovered polyol from a polyurethane product using a three-phase process wherein the polyurethane product is glycolyzed by using a catalyst and a glycolyzing compound comprises at least two hydroxyl groups and is selected from one or more long chain glycols having a specifically selected molecular weight, where the reaction mixture afterwards will split into an upper phase, a middle phase, and a bottom phase, wherein the upper phase is mainly formed by the recovered polyol (and may contain small amounts of unreacted glycolyzing compound). The middle phase may further be used in another run of the process. Hence, one aspect of the present invention relates to a process for obtaining a recycled polyol from a first polyurethane and use of said polyol as a component in a second polyurethane, wherein the process comprises the steps of: a) bringing the first polyurethane in contact with a catalyst and a molar excess of a glycolyzing compound to obtain a reaction mixture, wherein the glycolyzing compound comprises at least two hydroxyl groups and is selected from one or more long chain glycols having a molecular weight between 180 and 1100 g/mol; b) reacting the reaction mixture of step a) at a reaction temperature between 170 degrees C and 200 degrees C for a predefined reaction time between 30 minutes and 150 minutes to create a recycled mixture; c) separating the recycled mixture of step b) into at least three immiscible phases to obtain at least a recovered polyol phase, a glycolyzing compound phase, and an isocyanate-derivative and aromatic dicarbamate phase; and using the recovered polyol phase as a polyol component in a process for making the second polyurethane. Another aspect of the present invention relates to a process for obtaining a recycled polyol from a first polyurethane and use of said polyol as a component in a second polyurethane, wherein the process comprises the steps of: a) bringing the first polyurethane in contact with a catalyst and a molar excess of a glycolyzing compound to obtain a reaction mixture, wherein the glycolyzing compound comprises at least two hydroxyl groups and is selected from one or more long chain glycols having a molecular weight between 180 and 1100 g/mol; b) reacting the reaction mixture of step a) at a reaction temperature between 170 degrees C and 220 degrees C for a predefined reaction time between 30 minutes and 240 minutes to create a recycled mixture; c) separating the recycled mixture of step b) into at least three immiscible phases to obtain at least a recovered polyol phase, a glycolyzing compound phase, and a waste phase; and using the recovered polyol phase as a polyol component in a process for making the second polyurethane; wherein the glycolyzing compound and the first polyurethane are selected such that the glycolyzing compound has a density higher than the recycled polyol.

In other words, the invention is among others concerned with a process for glycolyzing a polyurethane by bringing scrap polyurethane in contact with a glycolyzing compound comprising at least two hydroxyl groups and selected from one or more long chain glycols having a molecular weight between 180 and 1100 g/mol, and a catalyst, where this catalyst promotes glycolysis of the polyurethane, let them react at elevated temperatures, and then let the mixture split into at least three phases, an upper phase, a middle phase, and a lower phase, where the upper phase is mainly formed by the recovered polyol from the polyurethane, the middle phase is formed by the remaining unreacted glycolyzing compound, and the lower phase is other by-products.

The upper phase/the recovered polyol phase is further used as a polyol or mixed with fresh polyol in the production of further polyurethane by incorporating it to a reaction mixture together with an isocyanate, in the presence of suitable catalysts and other additives commonly used.

In another aspect the present invention relates to a polyurethane prepared from a polyol mixture and one or more isocyanates, wherein the polyol mixture comprises at least 5% by weight of a recovered polyol phase obtained from the process for obtaining a recycled polyol as disclosed herein, such as at least 10% by weight, such as at least 15% by weight, such as at least 20% by weight, such as at least 25% by weight, such as at least 30% by weight, or such as at least 35% by weight of a recovered polyol phase.

The polyurethane may be an elastomeric polyurethane; hence in one or more embodiments, the first polyurethane and/or the second polyurethane is a polyurethane elastomer. Alternatively, the polyurethane may be a polyurethane foam; hence in one or more embodiments, the first polyurethane and/or the second polyurethane is a polyurethane foam.

The recovered polyol may be used in various amounts when preparing a new polyurethane depending on the physical and chemical properties required of said new polyurethane. Hence, in one or more embodiments, the polyol mixture comprises at least 10% by weight of a recovered polyol phase obtained from the process for obtaining a recycled polyol as disclosed herein. In another embodiment, the polyol mixture comprises at least 15% by weight of a recovered polyol phase obtained from the process for obtaining a recycled polyol as disclosed herein. In yet another embodiment, the polyol mixture comprises at least 20% by weight of a recovered polyol phase obtained from the process for obtaining a recycled polyol as disclosed herein. In a further embodiment, the polyol mixture comprises at least 25% by weight of a recovered polyol phase obtained from the process for obtaining a recycled polyol as disclosed herein. In yet another embodiment, the polyol mixture comprises at least 30% by weight of a recovered polyol phase obtained from the process for obtaining a recycled polyol as disclosed herein. In an even further embodiment, the polyol mixture comprises at least 35% by weight of a recovered polyol phase obtained from the process for obtaining a recycled polyol as disclosed herein.

In one or more embodiments, the polyol mixture comprises no more than 70% by weight of a recovered polyol phase obtained from the process for obtaining a recycled polyol as disclosed herein, such as no more than 60% by weight, such as no more than 50% by weight, or such as no more than 40% by weight of a recovered polyol phase obtained from the process for obtaining a recycled polyol as disclosed herein.

By weight in this regard is meant that it is compared to the weight of the total mixture including both the polyols and isocyanates used to create a new polyurethane.

In one or more embodiments, the glycolyzing compound phase is reused as the glycolyzing compound in another process for obtaining recycled polyol. Reusing the glycolyzing compound can be done because the recycled mixture is processed into at least three immiscible phases, such that the excess of the used glycolyzing compound is less contaminated after separation. Reusing the glycolyzing compound would also ensure that the process is greener and less expensive to run multiple times.

The glycolyzing compound may be selected from one or more polyethylene glycols having a molecular weight between 180 and 1100 g/mol, such as PEG 200, PEG 400, PEG 600, PEG 800 or PEG 1000. Thus, in one or more embodiments, the glycolyzing compound is selected from one or more polyethylene glycols having a molecular weight between 180 and 1100 g/mol, such as PEG 200, PEG 400, PEG 600, PEG 800 or PEG 1000.

In one or more embodiments, the glycolyzing compound is selected from one or more polyethylene glycols having a molecular weight between 380 and 420 g/mol, such as PEG 400.

In one or more embodiments, the glycolyzing compound is selected from PEG 400, PEG 600 and/or PEG 800. In one or more embodiments, the glycolyzing compound is PEG 400.

A phase separation is preferably optimized by utilizing different densities between the compounds that are to be separated. Hence, in one or more embodiments, the glycolyzing compound has a density and/or molecular weight different than the recycled polyol that is to be obtained by the recycling. In one or more embodiments, the density of the glycolyzing compound is at or above 1.1 g/cm³ (measured at 20 degrees C). In one or more embodiments, the density of the glycolyzing compound is at or above 1.2 g/cm³ (measured at 20 degrees C). In one or more embodiments, the density of the glycolyzing compound is at or above 1.15 g/cm³ (measured at 20 degrees C). In one or more embodiments, the density of the glycolyzing compound is at or above 1.20 g/cm³ (measured at 20 degrees C). In one or more embodiments, the density of the glycolyzing compound is at or above 1.13 g/cm³ (measured at 20 degrees C).

In one or more embodiments, the density of the recycled polyol is at or below 1.1 g/cm³ (measured at 20 degrees C). In one or more embodiments, the density of the recycled polyol is at or below 1.2 g/cm³ (measured at 20 degrees C). In one or more embodiments, the density of the recycled polyol is at or below 1.15 g/cm³ (measured at 20 degrees C). In one or more embodiments, the density of the recycled polyol is at or below 1.20 g/cm³ (measured at 20 degrees C).

In one or more embodiments, the density of the glycolyzing compound is above 1.1 g/cm³ (measured at 20 degrees C) and the density of the recycled polyol is below 1.1 g/cm³ (measured at 20 degrees C). In one or more embodiments, the density of the glycolyzing compound is above 1.2 g/cm³ (measured at 20 degrees C) and the density of the recycled polyol is below 1.2 g/cm³ (measured at 20 degrees C). In one or more embodiments, the density of the glycolyzing compound is above 1.15 g/cm³ (measured at 20 degrees C) and the density of the recycled polyol is below 1.15 g/cm³ (measured at 20 degrees C). In one or more embodiments, the density of the glycolyzing compound is above 1.20 g/cm³ (measured at 20 degrees C) and the density of the recycled polyol is below 1.20 g/cm³ (measured at 20 degrees C). In one or more embodiments, the density of the glycolyzing compound is at or above 1.12 g/cm³ (measured at 20 degrees C) and the density of the recycled polyol is at or below 1.11 g/cm³ (measured at 20 degrees C).

In one or more embodiments, the recycled polyol is selected from a difunctional polyether polyol, a trifunctional polyether polyol, a trifunctional polyether polyol based on glycerine, a higher functional polyether polyol based on sucrose, and/or a polytetramethylene ether glycol (PTMEG).

After step b) is completed and stopped, the recycled mixture may be allowed to cool or is cooled, the recycled mixture is then split into at least three phases, and collected separately by decanting the phases or by means of a mechanical operation such as centrifugation. The upper phase obtained thereby is mainly formed by the recycled/recovered polyol(s) obtained from the polyurethane reacted, the middle phase contains predominantly the excess of glycolyzing compound used, and the lower phase mainly comprising by-products such as isocyanate-derivatives and aromatic dicarbamates.

In one or more embodiments, the process further comprises cooling the recycled mixture prior to separating the recycled mixture in step c), wherein the cooling is conducted at a temperature of about 30 degrees C to about 60 degrees C, such as about 40 degrees C to about 50 degrees C.

In one or more embodiments, the process further comprises cooling the recycled mixture prior to separating the recycled mixture in step c), wherein the cooling is conducted at a temperature of about 30 degrees C to about 60 degrees C, such as about 40 degrees C to about 50 degrees C, and wherein the separation step c) is performed by maintaining the temperature obtained by the conducted cooling for a predefined period of at least 15 minutes, such as a predefined period of at least 1 hour, such as a predefined period of at least 6 hours, or such as a predefined period between 12 and 48 hours.

In one or more embodiments, the separation step c) is by spinning the recycled mixture with at least 3000-10000 rpm for a predefined period; and/or by maintaining or heating the recycled mixture to at least 30 degrees C, such as at least 40 degrees C, for a predefined period of at least 15 minutes; and/or by leaving the recycled mixture for a predefined period of at least 30 minutes.

The spinning of the recycled mixture with at least 3000-10000 rpm for a predefined period may e.g. be at 1200 G-force (RCF), 3000 RPM for 2 minutes. Other RCF and predefined periods may be selected based on the setup and the used glycolyzing compound.

In one or more embodiments, the separation step c) is by spinning the recycled mixture with at least 3000-10000 rpm for a predefined period. Again, the spinning of the recycled mixture with at least 3000-10000 rpm for a predefined period may e.g. be at 1200 G-force (RCF), 3000 RPM for 2 minutes. Other RCF and predefined periods may be selected based on the setup and the used glycolyzing compound.

In one or more embodiments, the separation step c) is by maintaining or heating the recycled mixture to at least 30 degrees C, such as at least 40 degrees C, for a predefined period of at least 15 minutes, such as a predefined period of at least 1 hour, such as a predefined period of at least 6 hours, or such as a predefined period between 12 and 48 hours. This embodiment may preferably be combined with the embodiment of cooling the recycled mixture prior to separating the recycled mixture in step c), wherein the cooling is conducted at a temperature of about 30 degrees C to about 60 degrees C.

In one or more embodiments, the separation step c) is leaving the recycled mixture for a predefined period of at least 30 minutes, such as a predefined period of at least 45 minutes, such as a predefined period of at least 1 hour, such as a predefined period of at least 6 hours, or such as a predefined period between 12 and 48 hours.

In one or more embodiments, the created recycled mixture of step b) is actively or passively cooled to a temperature between 30 and 60 degrees C and maintained at set temperature for a time period between 12 and 48 hours to create and separate the at least three immiscible phases of step c).

In one or more embodiments, the created recycled mixture of step b) is actively or passively cooled to a temperature between 30 and 60 degrees C and maintained at set temperature while centrifuging the recycled mixture between 3000 and 10000 RPM to create and separate the at least three immiscible phases of step c).

In one or more embodiments, the recovered polyol phase is used directly as a polyol component in a process for making a new polyurethane.

In one or more embodiments, the polyol phase is used in up to 60 wt. %, such as between 30 and 50 wt. %, of the total amount of reaction mixture used for making the second polyurethane. In one or more embodiments, the polyol phase is used in up to 40 wt. %, such as between 20 and 40 wt. %, of the total amount of reaction mixture used for making the second polyurethane. In one or more embodiments, the polyol phase is used in up to 35 wt. %, such as between 10 and 35 wt. %, of the total amount of reaction mixture used for making the second polyurethane.

In one or more embodiments, one or more of the recovered polyol phase, and/or the glycolyzing compound phase, and/or the isocyanate-derivative and aromatic dicarbamate phase is filtered after the separation step c).

In one or more embodiments, the first and second polyurethane are substantially the same polyurethane.

In one or more embodiments, the first polyurethane is prepared from at least a virgin polyol mixture and one or more isocyanates and the second polyurethane is prepared from at least a recycled polyol mixture and one or more isocyanates.

In one or more embodiments, the first polyurethane is prepared from only virgin polyol mixtures and one or more isocyanates and the second polyurethane is prepared from a combination of one or more recycled polyol mixtures, one or more virgin polyol mixtures, and one or more isocyanates.

In one or more embodiments, the first polyurethane is shredded, grinded, cut, chipped, and/or granulated prior to bringing the first polyurethane into contact with the catalyst and the molar excess of the glycolyzing compound to obtain the reaction mixture.

In carrying out the process of the invention, the polyurethane received for recycle is preferably chopped, scrapped, or ground to particles of relatively small size in order to reduce the time necessary for the reaction to take place, preferably having an average diameter between 1 mm and 5 cm.

In one or more embodiments, the first polyurethane is shredded, grinded, cut, chipped, and/or granulated to a diameter of no more than 3 mm prior to bringing the first polyurethane into contact with the catalyst and the molar excess of the glycolyzing compound to obtain the reaction mixture. In one or more embodiments, the diameter is no more than 2 mm, such as no more than 1 mm.

In one or more embodiments, the first and/or the second polyurethane has a shore from 50 A to 90 A. The shore hardness may be measured with a Durometer, and refer to the value determined by the penetration of the Durometer indenter foot into the sample being tested. The Shore A Hardness Scale measures the hardness of e.g. mould rubbers. These are softer and more flexible materials in general, but the scale gives an indication of whether they are extremely soft or if they are more rigid. In addition to soft rubbers, semi-rigid plastics can also be tested on the Shore A scale, but at the higher level.

In one or more embodiments, the first and/or the second polyurethane has a shore up to 90 D. The Shore D Hardness Scale measures the hardness of hard rubbers, semi-rigid plastics and hard plastics.

In one or more embodiments, the first and/or the second polyurethane has a shore between 50 A and 90 D, such as between 60 A and 90 D, such as between 50 A and 90 D, such as between 100 A and 90 D, or wherein the first and/or the second polyurethane has a shore between 50 A and 85 D, such as between 50 A and 80 D, such as between 50 A and 70 D, such as between 50 A and 60 D, such as between 50 A and 50 D, or such as between 50 A and 40 D.

In one or more embodiments, the first and/or the second polyurethane is formed from comonomers of at least methylene diphenyl diisocyanate (MDI) and polyether polyol.

In one or more embodiments, the catalyst is selected from a metal acetate salt, such as zinc acetate.

The glycolysis of the polyurethane is carried out in presence of a catalyst in order to enhance the reaction rate. The catalyst may be present in an amount of 0.001 to 10%, such as in an amount of 0.01 to 10%, such as in an amount of 0.1 to 10%, such as in an amount of 1 to 10%, such as in an amount of 1 to 8%, such as in an amount of 1 to 6%, and preferably between 2 and 4 by weight based on the weight of the polyurethane.

In one or more embodiments, the catalyst is in a concentration between 2 and 4 wt. % compared to 100 wt. % first polyurethane.

In one or more embodiments, the polyurethane and the glycolyzing compound is mixed in a ratio between 1:1 and 1:2. By X:Y is meant a weight to weight ratio, such that if e.g. the ratio I 1:2 and 1 kg of polyurethane is to be recycled 2 kg of glycolyzing compound is used in the process to recycle said 1 kg polyurethane.

In one or more embodiments, the reaction temperature is between 180 degrees C and 190 degrees C. In one or more embodiments, the reaction temperature is between 170 degrees C and 190 degrees C. In one or more embodiments, the reaction temperature is between 180 degrees C and 185 degrees C. In one or more embodiments, the reaction temperature is between 180 degrees C and 220 degrees C. In one or more embodiments, the reaction temperature is between 190 degrees C and 220 degrees C. In one or more embodiments, the reaction temperature is between 190 degrees C and 210 degrees C. In one or more embodiments, the reaction temperature is between 195 degrees C and 205 degrees C.

In one or more embodiments, the predefined reaction time is between 30 minutes and 150 minutes, such as 60 minutes and 100 minutes. In one or more embodiments, the predefined reaction time is between 60 minutes and 120 minutes, such as 60 minutes and 80 minutes. In one or more embodiments, the predefined reaction time is between 60 minutes and 240 minutes. In one or more embodiments, the predefined reaction time is between 90 minutes and 220 minutes. In one or more embodiments, the predefined reaction time is between 120 minutes and 200 minutes. In one or more embodiments, the predefined reaction time is between 150 minutes and 200 minutes. In one or more embodiments, the predefined reaction time is between 170 minutes and 190 minutes.

In one or more embodiments, wherein step a) comprises the following steps:
a1) providing the molar excess of the glycolyzing compound;
a2) adding the first polyurethane to the glycolyzing compound to obtain a pre-reaction mixture; and
a3) adding the catalyst to the pre-reaction mixture of step a2) to obtain the reaction mixture.

In one or more embodiments, the step of adding the first polyurethane to the glycolyzing compound is performed over a predefined time of less than 5 minutes.

In one or more embodiments, the glycolyzing compound of step a1) is heated to the reaction temperature prior to adding the first polyurethane in step a2).

In one or more embodiments, the first polyurethane is heated to a temperature above 60 degrees C prior to adding the first polyurethane to the glycolyzing compound in step a2).

The reaction may be carried out in air. Alternatively, the reaction is carried out in an inert gas atmosphere. A nitrogen atmosphere may be employed. This produces a product with less oxidative degradation and hence less coloration and less impurities than when carrying out of the reaction in air. In one or more embodiments, the process is performed under inert atmosphere, such as under N₂ atmosphere, prior to separating the recycled mixture in step c).

In one or more embodiments, the polyurethane is further prepared from a chain extender, such as a butanediol.

In one or more embodiment, the process further comprises a further first purification step of the recovered polyol phase, wherein the further first purification step comprises an extraction with a slightly acid aqueous solution, water, brine, propylene-, or ethylene oxide.

In one or more embodiments, the process further comprises a further second purification step of the glycolyzing compound phase, wherein the further second purification step comprises distillation under reduced pressure to obtain one or more distillate fractions containing the glycolyzing compound and one or more distillate fractions containing by-products.

In one or more embodiments, the reaction temperature is between 180 degrees C and 190 degrees C for a predefined reaction time between 30 minutes and 150 minutes to create the recycled mixture.

In one or more embodiments, the reaction temperature is between 170 degrees C and 190 degrees C for a predefined reaction time between 30 minutes and 150 minutes to create the recycled mixture.

In one or more embodiments, the reaction temperature is between 180 degrees C and 185 degrees C for a predefined reaction time between 30 minutes and 150 minutes min to create the recycled mixture.

In one or more embodiments, the reaction temperature is between 170 degrees C and 190 degrees C for a predefined reaction time between 30 minutes and 120 minutes to create the recycled mixture.

In one or more embodiments, the reaction temperature is between 180 degrees C and 190 degrees C for a predefined reaction time between 30 minutes and 120 minutes to create the recycled mixture.

In one or more embodiments, the reaction temperature is between 180 degrees C and 185 degrees C for a predefined reaction time between 30 minutes and 120 minutes min to create the recycled mixture.

In one or more embodiments, the reaction temperature is between 170 degrees C and 190 degrees C for a predefined reaction time between 60 minutes and 120 minutes to create the recycled mixture.

In one or more embodiments, the reaction temperature is between 180 degrees C and 190 degrees C for a predefined reaction time between 60 minutes and 120 minutes to create the recycled mixture.

In one or more embodiments, the reaction temperature is between 180 degrees C and 185 degrees C for a predefined reaction time between 60 minutes and 120 minutes min to create the recycled mixture.

In one or more embodiments, the reaction temperature is between 170 degrees C and 190 degrees C for a predefined reaction time between 60 minutes and 100 minutes to create the recycled mixture.

In one or more embodiments, the reaction temperature is between 180 degrees C and 190 degrees C for a predefined reaction time between 60 minutes and 100 minutes to create the recycled mixture.

In one or more embodiments, the reaction temperature is between 180 degrees C and 185 degrees C for a predefined reaction time between 60 minutes and 100 minutes min to create the recycled mixture.

In one or more embodiments, the reaction temperature is between 170 degrees C and 190 degrees C for a predefined reaction time between 60 minutes and 80 minutes to create the recycled mixture.

In one or more embodiments, the reaction temperature is between 180 degrees C and 190 degrees C for a predefined reaction time between 60 minutes and 80 minutes to create the recycled mixture.

In one or more embodiments, the reaction temperature is between 180 degrees C and 185 degrees C for a predefined reaction time between 60 minutes and 80 minutes min to create the recycled mixture.

In one or more embodiments, the reaction temperature is between 180 degrees C and 220 degrees C for a predefined reaction time between 60 minutes and 240 minutes to create the recycled mixture.

In one or more embodiments, the reaction temperature is between 180 degrees C and 220 degrees C for a predefined reaction time between 90 minutes and 220 minutes to create the recycled mixture. In one or more embodiments, the reaction temperature is between 180 degrees C and 220 degrees C for a predefined reaction time between 120 minutes and 200 minutes to create the recycled mixture. In one or more embodiments, the reaction temperature is between 180 degrees C and 220 degrees C for a predefined reaction time between 150 minutes and 200 minutes to create the recycled mixture. In one or more embodiments, the reaction temperature is between 180 degrees C and 220 degrees C for a predefined reaction time between 170 minutes and 190 minutes to create the recycled mixture.

In one or more embodiments, the reaction temperature is between 190 degrees C and 220 degrees C for a predefined reaction time between 60 minutes and 240 minutes to create the recycled mixture.

In one or more embodiments, the reaction temperature is between 190 degrees C and 220 degrees C for a predefined reaction time between 90 minutes and 220 minutes to create the recycled mixture. In one or more embodiments, the reaction temperature is between 190 degrees C and 220 degrees C for a predefined reaction time between 120 minutes and 200 minutes to create the recycled mixture. In one or more embodiments, the reaction temperature is between 190 degrees C and 220 degrees C for a predefined reaction time between 150 minutes and 200 minutes to create the recycled mixture. In one or more embodiments, the reaction temperature is between 190 degrees C and 220 degrees C for a predefined reaction time between 170 minutes and 190 minutes to create the recycled mixture.

In one or more embodiments, the reaction temperature is between 190 degrees C and 210 degrees C for a predefined reaction time between 60 minutes and 240 minutes to create the recycled mixture.

In one or more embodiments, the reaction temperature is between 190 degrees C and 210 degrees C for a predefined reaction time between 90 minutes and 220 minutes to create the recycled mixture. In one or more embodiments, the reaction temperature is between 190 degrees C and 210 degrees C for a predefined reaction time between 120 minutes and 200 minutes to create the recycled mixture. In one or more embodiments, the reaction temperature is between 190 degrees C and 210 degrees C for a predefined reaction time between 150 minutes and 200 minutes to create the recycled mixture. In one or more embodiments, the reaction temperature is between 190 degrees C and 210 degrees C for a predefined reaction time between 170 minutes and 190 minutes to create the recycled mixture.

In one or more embodiments, the reaction temperature is between 195 degrees C and 205 degrees C for a predefined reaction time between 60 minutes and 240 minutes to create the recycled mixture.

In one or more embodiments, the reaction temperature is between 195 degrees C and 205 degrees C for a predefined reaction time between 90 minutes and 220 minutes to create the recycled mixture. In one or more embodiments, the reaction temperature is between 195 degrees C and 205 degrees C for a predefined reaction time between 120 minutes and 200 minutes to create the recycled mixture. In one or more embodiments, the reaction temperature is between 195 degrees C and 205 degrees C for a predefined reaction time between 150 minutes and 200 minutes to create the recycled mixture. In one or more embodiments, the reaction temperature is between 195 degrees C and 205 degrees C for a predefined reaction time between 170 minutes and 190 minutes to create the recycled mixture.

In one or more embodiments, the glycolyzing compound was heated to 170-200 degrees C for 30 minutes under stirring and refluxing. After heating, a polyurethane was added to the heated glycolyzing compound. The polyurethane was a shredded polyurethane. After addition of the shredded polyurethane, the solution was heated for an additional 15 minutes. before Zinc Acetate was added to the solution. After addition of Zinc Acetate, the solution was heated for an additional 60 minutes. before the heating equipment was removed and replaced by cooling the solution to 120 degrees while still maintaining stirring of the solution. When the solution reached a temperature of 120 degrees, stirring of the solution was stopped and the solution was transferred to a separation funnel, where it was allowed to separate into three phases over a time period of 4 hours. The three phases were subsequently separated in three different containers for further use.

When describing the embodiments, the combinations and permutations of all possible embodiments have not been explicitly described. Nevertheless, the mere fact that certain measures are recited in mutually different dependent claims or described in different embodiments does not indicate that a combination of these measures cannot be used to advantage. The present invention envisages all possible combinations and permutations of the described embodiments.

### EXAMPLES

The present invention is further illustrated by the following examples, which are not to be construed as limiting the scope of protection. The features disclosed in the foregoing description and in the following examples may, both separately or in any combination thereof, be material for realising the invention in diverse forms thereof.

### Example 1

300 mL of the glycolyzing compound PEG 400 was heated to 185 degrees C for 19 minutes under stirring by a mechanical stirrer (300 rpm) and with refluxing using a reflux condenser. After heating for 19 minutes, 200 g polyurethane elastomer comprising methylene diphenyl diisocyanate (MDI) and polyether polyols with a shore A 55, was added to the heated PEG 400. The polyurethane elastomer was a shredded polyurethane having an average shredding size of 0.3 mm. Within 3 minutes after addition of the shredded polyurethane, the solution temperature decreased to 143 degrees C. The mixture was then heated for an additional 12 minutes to the setpoint temperature of 185 degrees Celsius before 3 g Zinc Acetate anhydrous was added to the solution. After addition of Zinc Acetate anhydrous, the solution was maintained at 185 degrees Celsius for an additional 60 minutes before the heating equipment was removed while still maintaining stirring of the solution. The reaction mixture was then poured into a separation funnel, where it was allowed to separate into three phases over a time period of 24 hours at 50 degrees Celsius. The three phases were subsequently separated into three different containers for further use.

### Example 2

The three phases obtained by the experiment described in example 1, was recovered a polyol phase, a glycolyzing compound phase, and an isocyanate-derivative and aromatic dicarbamate phase. The polyol phase was subsequently used for obtaining a new polyurethane elastomer by mixing the recycled polyol obtained in Example 1 with non-recycled polyol and isocyanate, in a vortex mixer for 30 seconds. Subsequently, the solution was transferred to a heating aluminium mould with a narrow opening of 3 mm thereby providing a 3 mm thick polyurethane sheet. The aluminium mould was heated to 90 degrees C and the polyurethane sheet was allowed to harden for 10 minutes in the aluminium mould before being transferred to an oven, where the polyurethane sheet was additionally cured for 16 hours at 100 degrees C.

Different weight ratios of recycled polyol obtained in Example 1 and non-recycled polyol were mixed in the vortex mixer according to Table 1 below. The content of polyol and isocyanate is measured so that it equates to a total mass 70 grams and also provided in Table 1.

TABLE 1

| | Product | Product | Product | Product |
|---|---|---|---|---|
| | 1 | 2 | 3 | 4 |
| Polyol content total (g) | 40.88 | 43.61 | 46.54 | 47.53 |
| wt % of recycled polyol | 0% | 15% | 30% | 37% |
| wt % of non-recycled polyol | 100% | 85% | 70% | 63% |
| Isocyanate content (g) | 29.12 | 26.39 | 23.46 | 21.69 |
| Ultimate tensile strength Mpa | 5.67 | 5.33 | 5.15 | 5.25 |
| Ultimate tensile displacement mm | 186.5 | 179.25 | 205.50 | 250.50 |
| Coefficient of friction (static) | 3.16 | 3.28 | 3.66 | 3.67 |

The ultimate tensile strength is measured by ISO 37/1A/20.

The ultimate tensile displacement is measured by ISO 37/1A/20.

The coefficient of friction (static) is measured by ISO 15113.

### Example 3

300 mL of the glycolyzing compound PEG 400 was heated to 180 or 200 degrees C for 19 minutes under stirring by a mechanical stirrer (300 rpm) and with refluxing using a reflux condenser. After heating for 19 minutes, polyurethane elastomer comprising methylene diphenyl diisocyanate (MDI) and polyether polyols with a shore A 55, was added to the heated PEG 400. The polyurethane elastomer was added in a weight corresponding to a ratio of 1:1 and 1:2 (polyurethane elastomer:glycolyzing compound—e.g. 325 g PEG 400 and 150 g Polyurethane elastomer is a 1:2 ratio). The polyurethane elastomer was a shredded polyurethane having an average shredding size of 0.3 mm. Within 3 minutes after addition of the shredded polyurethane, the solution temperature decreased to 143 degrees C. The mixture was then heated for an additional 12 minutes to the setpoint temperature of 180 or 200 degrees Celsius before 1 or 4 g Zinc Acetate anhydrous was added to the solution. After addition of Zinc Acetate anhydrous, the solution was maintained at 180 or 200 degrees Celsius for an additional 60 or 180 minutes before the heating equipment was removed while still maintaining stirring of the solution. The reaction mixture was then cooled and poured into a separation funnel, where it was allowed to separate into three phases over a time period of 24 hours at 50 degrees Celsius. The three phases were subsequently separated into three different containers for further analysis and determination of the recycled polyol deviation yield* (see table 2).

* The polyol deviation yield is calculated based on the theoretical polyol content of the polyurethane elastomer; this means that if e.g. 100 grams of polyol is in the polyurethane elastomer, then if the polyol deviation yield is close to 0 there will be 100 grams of said polyol in the upper polyol phase.

TABLE 2

| | Reaction | | | Reaction | | Polyol |
|---|---|---|---|---|---|---|
| Sample | temperature | | Catalyst | time | | deviation |
| # | (°C) | Ratio | (g) | (min) | Atmosphere | yield (%) |
| 1 | 180 | 1:2 | 4 | 60 | Oxygen | 102.55 |
| 2 | 180 | 1:2 | 4 | 180 | Nitrogen | 4.03 |
| 3 | 200 | 1:1 | 4 | 60 | Oxygen | 8.61 |
| 4 | 200 | 1:1 | 4 | 180 | Nitrogen | 2.80 |
| 5 | 200 | 1:1 | 1 | 60 | Nitrogen | 25.42 |
| 6 | 200 | 1:2 | 4 | 60 | Nitrogen | 14.32 |
| 7 | 180 | 1:1 | 1 | 60 | Oxygen | 128.18 |
| 8 | 180 | 1:2 | 1 | 60 | Nitrogen | 73.12 |
| 9 | 180 | 1:1 | 4 | 180 | Oxygen | 11.55 |
| 10 | 180 | 1:1 | 1 | 180 | Nitrogen | 44.16 |
| 11 | 200 | 1:2 | 1 | 180 | Nitrogen | 2.39 |
| 12 | 200 | 1:2 | 1 | 60 | Oxygen | 0.01 |
| 13 | 200 | 1:2 | 4 | 180 | Oxygen | 1.12 |
| 14 | 200 | 1:1 | 1 | 180 | Oxygen | 9.89 |
| 15 | 180 | 1:1 | 4 | 60 | Nitrogen | 72.08 |
| 16 | 180 | 1:2 | 1 | 180 | Oxygen | 26.36 |

Table 2 displays the results for polyol deviation yield (%) based on five distinct variables:reaction temperature (°C), ratio, amount of catalyst (g), reaction time (min), and atmosphere. Based on statistical analysis (not shown) it can be observed that ratio, catalyst, and atmosphere all overlap with similar medians (statistically insignificant), while for reaction temperature and reaction time there is not an overlap, as 200 degrees C and 180 min gives a lower polyol deviation yield.

Specifically, when 180 degrees C reaction temperature is employed, the polyol deviation yield is 51.85±27.74 wt. % higher than when 200 degrees C is used, while when 60 min reaction time is employed, the polyol deviation yield is 40.66±27.74 wt. % higher than when 180 min is used.

Lastly, it can be observed that there is a positive synergistic effect between the reaction temperature at or around 200 degrees C with a reaction time at or around 180 minutes.

1. A process for obtaining a recycled polyol from a first polyurethane and use of the recycled polyol as a component in a second polyurethane, wherein the process comprises:
bringing a first polyurethane in contact with a catalyst and a molar excess of a glycolyzing compound to obtain a reaction mixture, wherein the glycolyzing compound comprises at least two hydroxyl groups and is selected from one or more long chain glycols having a molecular weight between 180 and 1100 g/mol;
reacting the reaction mixture at a reaction temperature between 170 degrees C and 220 degrees C for a predefined reaction time between 30 minutes and 240 minutes to create a recycled mixture;
separating the recycled mixture into at least three immiscible phases to obtain at least a recovered polyol phase, a glycolyzing compound phase, and a waste phase; and
using the recovered polyol phase as a polyol component in a process for making a second polyurethane;
wherein the glycolyzing compound and the first polyurethane are selected such that the glycolyzing compound has a density higher than a density of the recovered polyol.

2. The process according to claim 1, wherein the glycolyzing compound phase is reused as the glycolyzing compound in another process for obtaining recycled polyol.

3. The process according to claim 1, wherein the glycolyzing compound is selected from one or more polyethylene glycols having a molecular weight between 380 and 420 g/mol.

4. The process according to claim 1, wherein the separating of the recycled mixture comprises spinning the recycled mixture with at least 3000-10000 rpm for a predefined period; and/or by maintaining or heating the recycled mixture to at least 30 degrees C for a predefined period of at least 15 minutes; and/or by leaving the recycled mixture for a predefined period of at least 30 minutes.

5. The process according to claim 1, wherein the recovered polyol phase is used directly as a polyol component in a process for making a new polyurethane.

6. The process according to claim 1, wherein the polyol phase is used in up to 60 wt. % of a total amount of reaction mixture used for making the second polyurethane.

7. The process according to claim 1, wherein the process further comprises cooling the recycled mixture prior to the separating the recycled mixture, wherein the cooling is conducted at a temperature of about 30 degrees C to about 60 degrees C.

8. The process according to claim 1, wherein the first polyurethane and the second polyurethane are substantially the same polyurethane.

9. The process according to claim 1, wherein the catalyst is selected from a metal acetate salt.

10. The process according to claim 1, wherein the catalyst is in a concentration between 2 and 4 wt. % compared to 100 wt. % of the first polyurethane.

11. The process according to claim 1, wherein the first polyurethane and the glycolyzing compound are mixed together in a ratio between 1:1 and 1:2.

12. The process according to claim 1, wherein the reaction temperature is between 180 degrees C and 220 degrees C.

13. The process according to claim 1, wherein the predefined reaction time is between 60 minutes and 240 minutes.

14. The process according to claim 1, wherein the bringing of the first polyurethane in contact with the catalyst and the molar excess of a glycolyzing compound to obtain the reaction mixture comprises:
providing the molar excess of the glycolyzing compound;
adding the first polyurethane to the glycolyzing compound to obtain a pre-reaction mixture; and
adding the catalyst to the pre-reaction mixture to obtain the reaction mixture.

15. A polyurethane prepared from a polyol mixture and one or more isocyanates, wherein the polyol mixture comprises at least 5% by weight of a recovered polyol phase obtained from a process for obtaining a recycled polyol comprising:
bringing a first polyurethane in contact with a catalyst and a molar excess of a glycolyzing compound to obtain a reaction mixture, wherein the glycolyzing compound comprises at least two hydroxyl groups and is selected from one or more long chain glycols having a molecular weight between 180 and 1100 g/mol;
reacting the reaction mixture at a reaction temperature between 170 degrees C and 220 degrees C for a predefined reaction time between 30 minutes and 240 minutes to create a recycled mixture;
separating the recycled mixture-into at least three immiscible phases to obtain at least a recovered polyol phase, a glycolyzing compound phase, and a waste phase; and
wherein the glycolyzing compound and the first polyurethane are selected such that the glycolyzing compound has a density higher than a density of the recovered polyol.
